(19) United States
(12) Patent Application Publication
(10) Pub. No.: US 2012/0272943 A1
(43) Pub. Date: Nov. 1, 2012

(54) DIAMOND WIRE SAW DEVICE

(75) Inventor: Jingxin SONG, Guilin (CN)

(73) Assignee: GUILIN CHAMPION UNION DIAMOND CO., LTD., Guilin (CN)

(21) Appl. No.: 13/479,261

(22) Filed: May 23, 2012

Related U.S. Application Data
(63) Continuation-in-part of application No. PCT/CN2012/071788, filed on Feb. 29, 2012.

(30) Foreign Application Priority Data
Apr. 29, 2011 (CN) 201110112869.1

(51) Int. Cl. B28D 5/00

(52) U.S. Cl. 125/21

(57) ABSTRACT

A diamond wire saw device including a diamond sawing wire. At least two diamond sawing wires are arranged in the front and back of a cutting working surface along a cutting feed direction, or at least two groups of the diamond sawing wires are arranged in the front and back of more than one parallel cutting working surface. The diamond sawing wires in the same group are parallel to one another to form a layer of cutting mesh surface. The diameter of a latter diamond sawing wire or a latter group of diamond sawing wires is equal to or greater than that of a former diamond sawing wire or a former group of diamond sawing wires.

### CROSS-REFERENCE TO RELATED APPLICATIONS

This application is a continuation-in-part of International Patent Application No. PCT/CN2012/071788 with an international filing date of Feb. 29, 2012, designating the United States, now pending, and further claims priority benefits to Chinese Patent Application No. 201110112869.1 filed Apr. 29, 2011. The contents of all of the aforementioned applications, including any intervening amendments thereto, are incorporated herein by reference.

### CORRESPONDENCE ADDRESS

Inquiries from the public to applicants or assignees concerning this document should be directed to: MATTHIAS SCHOLL P.C., ATTN.: DR. MATTHIAS SCHOLL ESQ., 14781 MEMORIAL DRIVE, SUITE 1319, HOUSTON, Tex. 77079.

### BACKGROUND OF THE INVENTION

1. Field of the Invention

The invention relates to a processing device for hard and brittle non-metallic materials and more particularly to a diamond wire saw device for cutting silicon ingots.

2. Description of the Related Art

Cutting the solid silicon ingots of monocrystalline silicon or polycrystalline silicon is a critical process for the manufacture of solar photovoltaic cells. The silicon ingots are cut into square blocks, and then cut into thin silicon wafers. A multi-wire saw is the most common and the most mature slicing equipment at present. A group of parallel spool is arranged in the working area of the multi-wire saw, sawing wires parallel to one another are wound on the spool to form a square cutting wire mesh (as shown in FIG. 1) running at a certain linear speed. An upper horizontal wire mesh surface and a lower horizontal wire mesh surface of the cutting wire mesh are silicon ingot cutting surfaces. The silicon ingots are fixed on a cutting table. The cutting table vertically penetrates the upper horizontal wire mesh surface and the lower horizontal wire mesh surface, and the multi-wire saw provides free abrasives slurry for the sawing wire during cutting, so that the silicon ingots are cut into silicon wafers.

The cutting method of a wire saw machine has been greatly improved technically compared with a traditional band saw cutting method and ID blades slicing method, but there are still a lot problems such as surface cracks of surface cutting by abrasive slurry, uncontrollable depth of the affected layer, difficulty in separation between abrasive particles and silicon crumbs, harsh working environment, and lower efficiency.

The cutting method of diamond wire saw with micro abrasive concretion is a new processing method proposed for solving the above problems. From the present research achievements, the diamond wire saw with abrasive concretion has the advantages of ease in recovery of silicon crumbs, good working environment and small damage of the cutting surface, high efficiency, thin slicing, thickness equalization and the like.

The abrasive particles concretion method of the diamond wire saw mainly includes: (1) fixing with resin bond (including metal and non-metal core wires); (2) fixing by mechanical extrusion (metal core wire); (3) fixing by brazing (metal core wire); (4) fixing with electroplated abrasive (metal core wire) . Each diamond wire saw with abrasive concretion has different characteristics, but also has obvious defects.
(1) As to the resin bond diamond wire saw with abrasive concretion, the finishing surface quality is good, but the efficiency is low, the resin heat resistance is poor, the bonding strength is low, the diameter of the wire saw is easily worn, the change in kerf is great, and the subsequent processing cost may be increased due to the out-of-tolerance in thickness of the silicon wafer.
(2) As to the diamond wire saw with abrasive concretion by mechanical extrusion, the working efficiency is high, but the core wire is damaged under extrusion, the life is affected after the strength degradation, and the finishing quality of surface is difficult to guarantee.
(3) As to the diamond wire saw with abrasive concretion by brazing (metal core wire), the working efficiency is high, but the strength and toughness of the core wire are destroyed due to the high temperature during the brazing process, the manufacturing process is complex, and the difficulty in volume production is high.
(4) As to the diamond wire saw with abrasive concretion by electroplated abrasive (metal core wire), the retention of wire diameter is good, but the finishing quality is not satisfying, and the wire saw is easily broken to lead to higher cutting cost.

In China, the above four categories of products have been partially applied on silicon materials bricking, but are not yet widely used. Its main reason lies in that the diamond multi-wire saw performs one-time cutting to the silicon ingot by adopting the same wire, it's difficult to meet the requirements of surface finishing quality, efficiency, service life, and cost performance of the silicon wafer at the same time, and in addition, the performance of the matching equipment and the processing technology are also unsatisfactory.

### SUMMARY OF THE INVENTION

In view of the above-described problems, it is one objective of the invention to provide a diamond wire saw device for meeting the requirements of surface finishing quality, efficiency, service life and cost performance of silicon wafers through multi-cutting with diamond wire saws with different characteristics during silicon wafering.

To achieve the above objective, in accordance with one embodiment of the invention, there is provided a diamond wire saw device comprising a diamond sawing wire, wherein at least two diamond sawing wires are arranged in the front and back of a cutting working surface along a cutting feed direction, or at least two groups of the diamond sawing wires are arranged in the front and back of more than one parallel cutting working surface, and the diamond sawing wires in the same group are parallel to one another to form a layer of cutting mesh surface; the diameter of a latter diamond sawing wire or a latter group of diamond sawing wires is equal to or greater than that of a former diamond sawing wire or a former group of diamond sawing wires.

In a class of this embodiment, the cutting mesh surface is formed by winding one or more long diamond sawing wires on one group of spool.

In a class of this embodiment, in one group of spools, a square mesh surface is formed by at least two spools, a triangular mesh surface is formed by three spools, or a polygonal mesh surface is formed by more spools.

Conventionally, four spools are arranged in the four corners to form a square wire mesh. The number of the square wire mesh is two groups or more, and each group of the square wire meshes is combined to form a two-layer or multi-layer cutting mesh surface.

A two-layer or three-layer cutting mesh surface is taken as an example:

Two groups of the square wire meshes are nested to form a concentric hollow square, or two groups of the square wire meshes are distributed in the front and in the back along the cutting feed direction.

Three groups of the square wire meshes are nested with one another; or a group of the square wire meshes are distributed in front of or behind two groups of the square wire meshes nested to form a concentric hollow square along the cutting feed direction.

In a class of this embodiment, the wire diameter of the latter diamond sawing wire or the latter group of diamond sawing wires is equal to but preferably greater than that of the former diamond sawing wire or the former group of diamond sawing wires; the size of diamond grains attached onto the latter diamond sawing wire or the latter group of diamond sawing wires is equal to but preferably smaller than that of diamond grains attached onto the former diamond sawing wire or the former group of diamond sawing wires.

In a class of this embodiment, the relationship between the adjacent diamond sawing wires or between the adjacent cutting mesh surfaces is parallel, and to better eliminate the cut marks formed on the surface of the silicon wafer during the former cutting of the diamond sawing wire, an included angle can be formed between the adjacent diamond sawing wires or the adjacent cutting mesh surfaces.

In a class of this embodiment, when the strength of the silicon wafer is sufficient, the running directions of the adjacent diamond sawing wires or the adjacent cutting mesh surfaces can be the same, however, the running directions are preferably opposite for keeping the cutting stability.

According to the fundamental principles of diamond processing, the grain size of diamond plays a decisive role for the cutting efficiency and surface roughness, and the cutting efficiency can be improved by adopting the more coarse diamond, however, the surface roughness is poorer; a better surface roughness can be obtained by adopting the finer diamond, however, the cutting efficiency is greatly affected. Thus, all diamond sawing wires can independently run with different parameters, for the purposes of cutting, fine grinding, and polishing of different diamond sawing wires to the silicon wafer. By adopting the technical scheme of the diamond wire saw device, the diamond sawing wires corresponding to the process are selectively used in different cutting wire meshes according to the different demands of cutting, coarse grinding, and fine grinding, so that the wire diameter and the grain size of diamond are appropriate to the process, not only the cutting efficiency is improved, but also the requirements of surface roughness are met, and the cut silicon wafers are further developed towards the bigger and thinner silicon wafers.

Advantages of the invention are summarized below:

By adopting the method of cutting the silicon wafers in sequence via the cutting mesh surfaces of a plurality of groups of diamond sawing wires, the cutting, fine grinding, and polishing procedures of the silicon wafer are finished via the diamond sawing wires with different characteristics according to different working parameters; the machining allowance of cutting, fine grinding, and polishing is greatly lowered in sequence, and the shearing force to the silicon wafer during the processing is greatly reduced in sequence, so as to be favorable for the formation of thin sheets, thus the higher utilization ratio of silicon materials is obtained, the requirements of developing the narrower cutting seams and the thinner cut silicon wafers is met, the problem that the requirements of the grain size of diamond to the cutting efficiency and the surface roughness cannot be met at the same time is solved, and the selection of the grain size of diamond is wider.

### BRIEF DESCRIPTION OF THE DRAWINGS

FIG. 1 is a three-dimensional structural diagram of a group of square wire meshes formed by winding a diamond sawing wire on a group (four) of spools in a traditional diamond wire saw machine;

FIG. 2 is a front view of FIG. 1;

FIG. 3 is a structural diagram of a first example of a diamond wire saw device;

FIG. 4 is a structural diagram of a second example of a diamond wire saw device;

FIG. 5 is a structural diagram of a third example of a diamond wire saw device;

FIG. 6 is a structural diagram of a fourth example of a diamond wire saw device;

FIG. 7 is a structural diagram of a fifth example of a diamond wire saw device; and

FIG. 8 is a diagram illustrating the cutting, fine grinding, and polishing of three different diamond sawing wires in the same silicon slit in FIG. 3, FIG. 4, and FIG. 5.

In the drawings, the following reference numbers are used: 1. Cutting table 1 for fixing silicon rod; 2. Diamond sawing wire; 3. spool.

### DETAILED DESCRIPTION OF THE EMBODIMENTS

The technical scheme of a diamond wire saw device is described by taking a three-layer cutting mesh surface and a two-layer cutting mesh surface as examples.

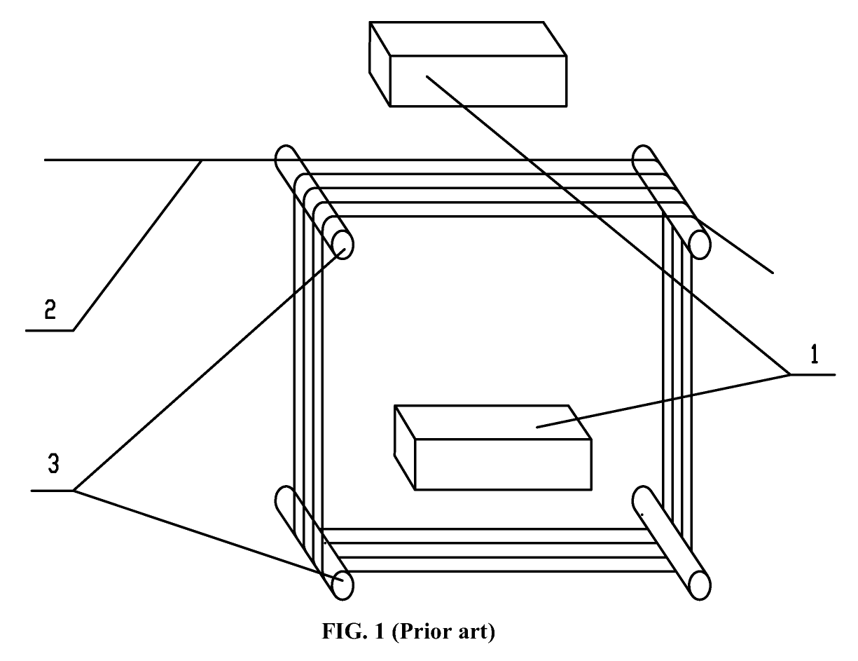

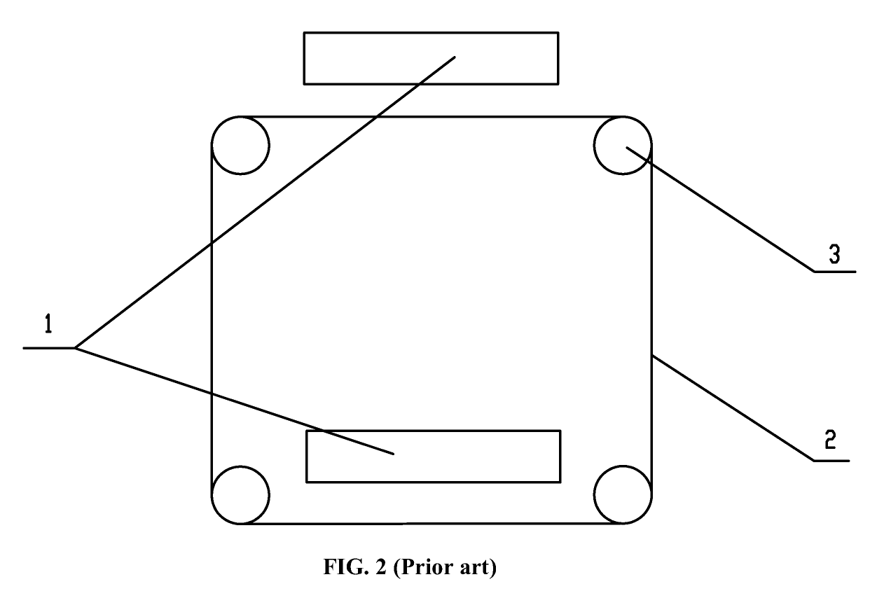

1. In the silicon wafer cutting process of a three-layer cutting mesh surface, three vertically aligned diamond sawing wires 2 are used for cutting, finely grinding, and polishing the same silicon slit. Each layer of the cutting mesh surface comprises mesh surfaces of a group of wire meshes formed by winding long diamond sawing wires 2 on a group of spools 3; each group of the spools 3 are arranged in the four corners to form a square wire mesh. As shown in FIG. 1 and FIG. 2, the upper mesh surface and the lower mesh surface in the square wire mesh corresponding to a cutting table 1 for fixing silicon rods are cutting mesh surfaces.

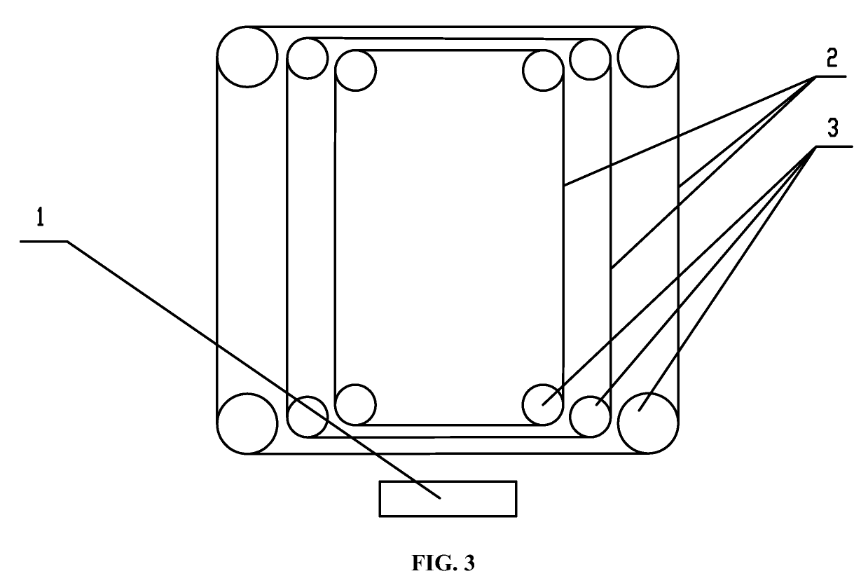

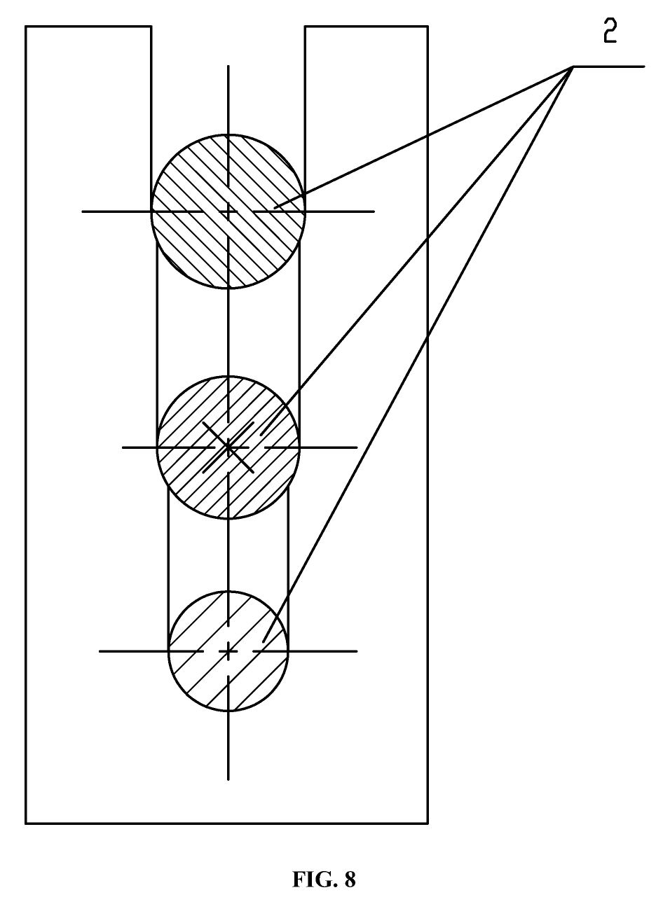

A. The three-layer cutting mesh surface comprises mesh surfaces of three groups of wire meshes formed by winding three diamond sawing wires 2 on three groups of spools 3. As shown in FIG. 3 and FIG. 8, the three-layer cutting mesh surface is formed by three lower diamond sawing wires 2. The cutting table 1 for fixing silicon rods is arranged below the three-layer cutting mesh surface. The operation of cutting, fine grinding, and polishing is carried out in sequence from outside to inside.

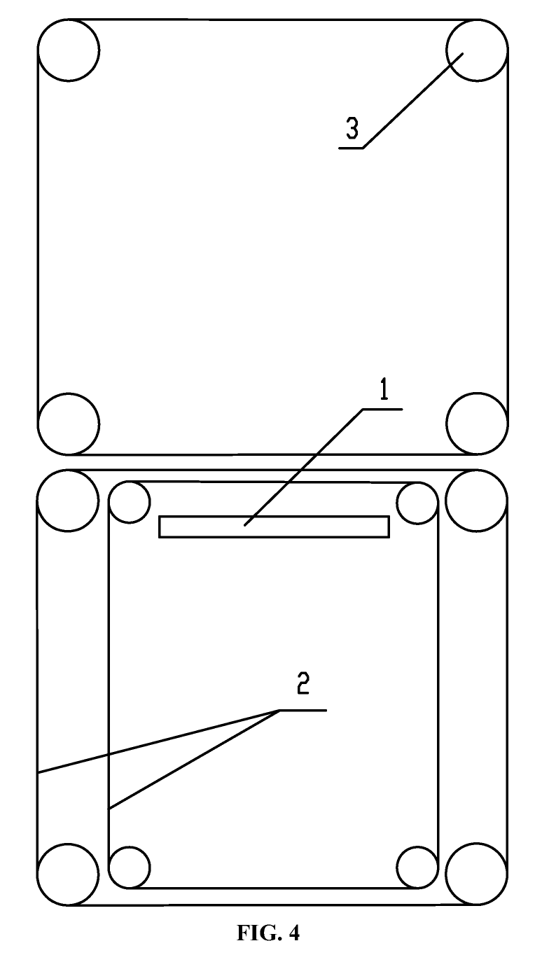

B. The three-layer cutting mesh surface comprises mesh surfaces of three groups of wire meshes formed by winding three diamond sawing wires 2 on three groups of spools 3. Two groups of wire meshes are mutually nested to form a concentric hollow square, and a square wire mesh is positioned above the wire meshes with a concentric hollow square. As shown in FIG. 4 and FIG. 8, the three-layer cutting mesh surface is formed by a lower diamond sawing wire 2 of the square wire mesh and two upper diamond sawing wires 2 of the wire meshes with a concentric hollow square. The cutting table 1 for fixing silicon rods is arranged below the three-layer cutting mesh surface. The operation of cutting, fine grinding, and polishing is carried out in sequence from inside to outside of the wire meshes with a concentric hollow square, and then gets through the lower diamond sawing wire 2 of the square wire mesh.

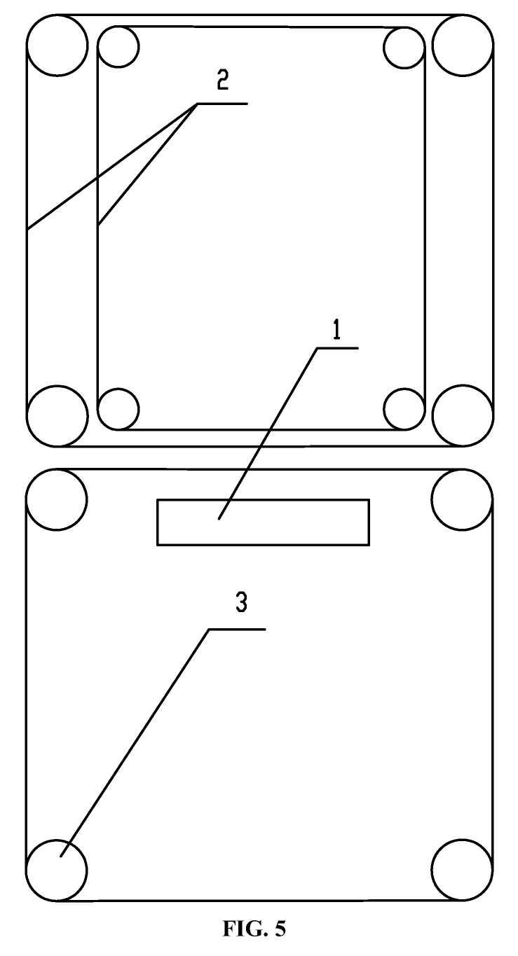

C. The three-layer cutting mesh surface comprises mesh surfaces of three groups of wire meshes formed by winding three diamond sawing wires 2 on three groups of spools 3. Two groups of wire meshes are mutually nested to form a concentric hollow square, and a square wire mesh is positioned below the wire meshes with a concentric hollow square. As shown in FIG. 5 and FIG. 8, the three-layer cutting mesh surface is formed by two lower diamond sawing wires 2 of the wire meshes with a concentric hollow square and an upper diamond sawing wire 2 of the square wire mesh. The cutting table 1 for fixing silicon rods is arranged below the three-layer cutting mesh surface. The operation of cutting, fine grinding, and polishing is carried out in sequence from outside to inside of the wire meshes with a concentric hollow square after getting through the upper diamond sawing wire 2 of the square wire mesh.

In A, B, and C, the diameter of the diamond sawing wire 2 of each layer of cutting mesh surface is gradually increased according to the cutting sequence, the wire diameter of the diamond sawing wire 2 is gradually thickened, and the size of diamond grains attached on the wire diameter of the diamond sawing wire 2 is gradually reduced.

2. In the silicon wafer cutting process of a two-layer cutting mesh surface, two vertically aligned diamond sawing wires are used for cutting and grinding the same silicon slit; each layer of cutting mesh surface comprises mesh surfaces of a group of wire meshes formed by winding a diamond sawing wire 2 on a group of spools 3; each group of the spools 3 is arranged in the four corners to form a square wire mesh. As shown in FIG. 1 and FIG. 2, the upper mesh surface and the lower mesh surface corresponding to the cutting table 1 for fixing silicon rods are cutting mesh surfaces.

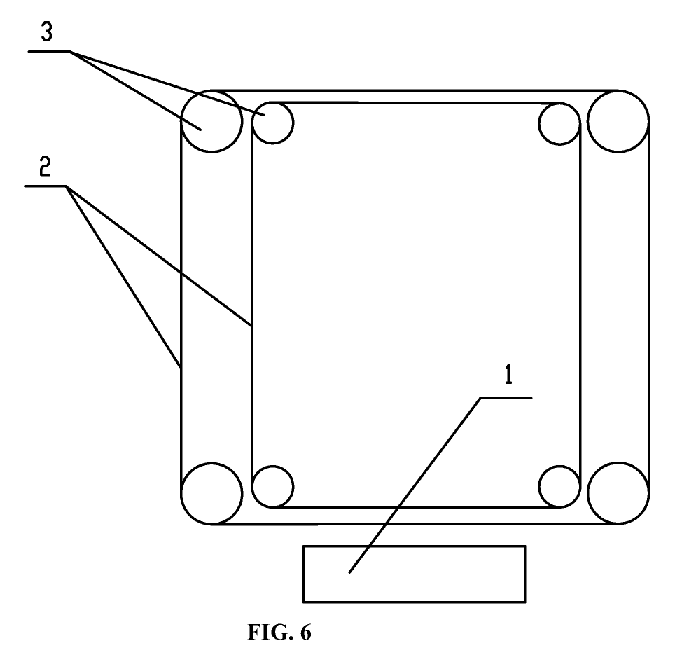

D. The two-layer cutting mesh surface comprises mesh surfaces of two groups of wire meshes formed by winding two diamond sawing wires 2 on two groups of spools 3; the two groups of the wire meshes are mutually nested to form a concentric hollow square. As shown in FIG. 6, the two-layer cutting mesh surface is formed by two lower diamond sawing wires 2. The cutting table 1 for fixing silicon rods is arranged below the two-layer cutting mesh surface. The operation of cutting and grinding is carried out in sequence from outside to inside.

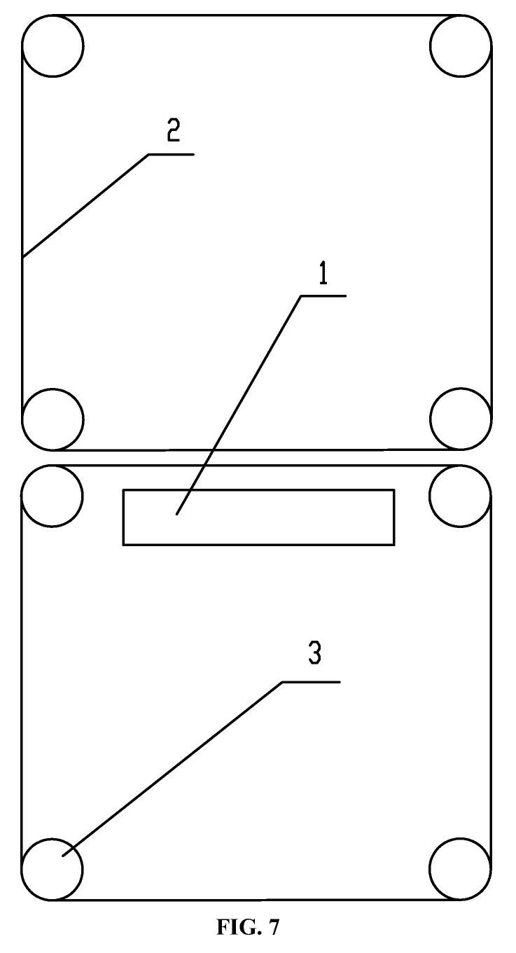

E. The two-layer cutting mesh surface comprises mesh surfaces of two groups of wire meshes formed by winding two diamond sawing wires 2 on two groups of spools 3; the two groups of the wire meshes are vertically arranged to form an upper square wire mesh and a lower square wire mesh. As shown in FIG. 7, the two-layer cutting mesh surface is formed by a lower diamond sawing wire 2 of the upper square wire mesh and an upper diamond sawing wire 2 of the lower square wire mesh. The cutting table 1 is arranged below the two-layer cutting mesh surface. The operation of cutting and grinding is carried out in sequence from the upper diamond sawing wire 2 of the lower square wire mesh to the lower diamond sawing wire 2 of the upper square wire mesh.

In D and E, the diameter of the diamond sawing wire 2 of the first layer of the cutting mesh surface is gradually increased, the wire diameter of the diamond sawing wire 2 of the second layer of the cutting mesh surface is greater than that of the diamond sawing wire 2 of the first layer of the cutting mesh surface, and the size of diamond grains attached on the wire diameter of the diamond sawing wire 2 of the second layer of the cutting mesh surface is smaller than that of diamond grains attached on the wire diameter of the diamond sawing wire 2 of the first layer of the cutting mesh surface.

In A, B, C, D, and E, a certain included angle is formed between the adjacent cutting mesh surfaces and the running direction of the adjacent cutting mesh surfaces are opposite.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A diamond wire saw device, comprising a diamond sawing wire (2), wherein
at least two diamond sawing wires are arranged in the front and back of a cutting working surface along a cutting feed direction, or at least two groups of the diamond sawing wires (2) are arranged in the front and back of more than one parallel cutting working surface;
the diamond sawing wires (2) in the same group are parallel to one another to form a layer of cutting mesh surface; and
the diameter of a latter diamond sawing wire or a latter group of diamond sawing wires (2) is equal to or greater than that of a former diamond sawing wire (2) or a former group of diamond sawing wires (2).

2. The diamond wire saw device of claim 1, wherein the cutting mesh surface is formed by winding one or more long diamond sawing wires (2) on one group of spools (3).

3. The diamond wire saw device of claim 2, wherein in one group of spools (3), a square mesh surface is formed by at least two spools (3), a triangular mesh surface is formed by three spools (3), or a polygonal mesh surface is formed by more spools (3).

4. The diamond wire saw device of claim 3, wherein four spools (3) are arranged in four corners to form a square wire mesh.

5. The diamond wire saw device of claim 4, wherein the square wire mesh is two or more groups in number, and each group of the square wire meshes is combined to form a two-layer or multi-layer cutting mesh surface.

6. The diamond wire saw device of claim 5, wherein two groups of the square wire meshes are nested to form a concentric hollow square, or two groups of the square wire meshes are distributed in the front and in the back along the cutting feed direction.

7. The diamond wire saw device of claim 5, wherein three groups of the square wire meshes are nested with one another; or a group of the square wire meshes are distributed in front of or behind two groups of the square wire meshes which are nested to form a concentric hollow square along the cutting feed direction.

8. The diamond wire saw device of claim 1, wherein
the wire diameter of the latter diamond sawing wire or the latter group of diamond sawing wires (2) is equal to or greater than that of the former diamond sawing wire or the former group of diamond sawing wires (2); and
the size of diamond grains attached onto the latter diamond sawing wire or the latter group of diamond sawing wires (2) is equal to or smaller than that of diamond grains attached onto the former diamond sawing wire or the former group of diamond sawing wires (2).

9. The diamond wire saw device of claim 6, wherein
the wire diameter of the latter diamond sawing wire or the latter group of diamond sawing wires (2) is equal to or greater than that of the former diamond sawing wire or the former group of diamond sawing wires (2); and
the size of diamond grains attached onto the latter diamond sawing wire or the latter group of diamond sawing wires (2) is equal to or smaller than that of diamond grains attached onto the former diamond sawing wire or the former group of diamond sawing wires (2).

10. The diamond wire saw device of claim 7, wherein
the wire diameter of the latter diamond sawing wire or the latter group of diamond sawing wires (2) is equal to or greater than that of the former diamond sawing wire or the former group of diamond sawing wires (2); and
the size of diamond grains attached onto the latter diamond sawing wire or the latter group of diamond sawing wires (2) is equal to or smaller than that of diamond grains attached onto the former diamond sawing wire or the former group of diamond sawing wires (2).

11. The diamond wire saw device of claim 1, wherein an included angle is formed between adjacent diamond sawing wires (2) or adjacent cutting mesh surfaces.

12. The diamond wire saw device of claim 6, wherein an included angle is formed between adjacent diamond sawing wires (2) or adjacent cutting mesh surfaces.

13. The diamond wire saw device of claim 7, wherein an included angle is formed between adjacent diamond sawing wires (2) or adjacent cutting mesh surfaces.

14. The diamond wire saw device of claim 1, wherein the running directions of adjacent diamond sawing wires (2) or adjacent cutting mesh surfaces is the same or opposite.

15. The diamond wire saw device of claim 6, wherein the running directions of adjacent diamond sawing wires (2) or adjacent cutting mesh surfaces is the same or opposite.

16. The diamond wire saw device of claim 7, wherein the running directions of adjacent diamond sawing wires (2) or adjacent cutting mesh surfaces is the same or opposite.
